(19) United States
(12) Patent Application Publication
(10) Pub. No.: US 2024/0367874 A1
(43) Pub. Date: Nov. 7, 2024

(54) LAUNDRY PRODUCT HAVING A DRAIN BACK CLOSURE

(71) Applicant: The Procter & Gamble Company, Cincinnati, OH (US)

(72) Inventors: Nicole Lynn BRIGGS, West Chester, OH (US); Sarah Ann DELANEY, Hebron, KY (US); Gauravi SHAH, Newport, KY (US)

(21) Appl. No.: 18/143,671

(22) Filed: May 5, 2023

(51) Int. Cl. B65D 47/40; B65D 1/02; B65D 41/02; B65D 43/16; B65D 47/06; B65D 51/18; C11D 1/83; C11D 3/20; C11D 17/04

(52) U.S. Cl. CPC B65D 47/40; B65D 1/02; B65D 41/023; B65D 43/16; B65D 47/06; B65D 51/18; C11D 1/83; C11D 3/2086; C11D 17/046; B65D 2251/0021; B65D 2251/0078; B65D 2543/00092; B65D 2543/0099; C11D 1/22

(57) ABSTRACT

A laundry product including a liquid composition having a pH from 1 to 6; and a container including a base, a sidewall extending from said base to a neck; and a closure. The closure includes a top profile having a spud projecting from the interior surface thereof and engaged with a main body; an abutment in the main body sealingly engaged with the spud, wherein the abutment extends around a longitudinal axis; a collar engaged with the abutment and oriented away from the top profile; a floor peripherally bounded by the abutment; a sealing member that is at least part of the floor, wherein the sealing member is peripherally bounded by a frangible boundary extending around the longitudinal axis; a tab extending from the sealing member towards the top profile; wherein the sealing member and the abutment are a continuous single constitutive material.

### FIELD OF THE INVENTION

Laundry product having a drain back closure

### BACKGROUND OF THE INVENTION

Users of laundry product continue to demand better performing packaging for laundry products. A tension that often arises in developing better performing packages is that improved performance comes with increased cost to the manufacturer. A business practicality is that typically, at least some of that increased cost is reflected in the price the consumer pays for the laundry product.

Users' perceptions of the performance of laundry products are largely generated based on the perceived effects of treating laundry with the laundry product. As such, the manufacturer must make choices on what consumer benefits will generate the most value for the consumer. If the manufacturer is able to improve the performance of the packaging and at the same time lower the cost of the packaging, that may enable the manufacturer to invest in upgrades to the formula of the laundry product or provide a greater quantity of laundry product for a similar price.

Drain back closures have historically been complicated devices. In a common design, a drain back closure fitment is engaged with a container and a separate closure is engaged with the drain back closure fitment. This design requires molding multiple parts, handling multiple parts on a manufacturing line, and assembling multiple parts on a manufacturing line. This can require multiple molding machines and custom machinery to handle and assemble individual components of the drain back closures. Since many laundry products are liquid laundry products, leaky packaging can be a concern. Each connection between parts, for example the drain back closure fitment to the neck of the bottle and the closure to the drain back closure fitment, is a connection that can be prone to leakage. Leakage that might occur from the time the package leaves the manufacturing site to when the package is stored in the user's home is of particular concern to manufacturers.

Some liquid laundry products are known to be prone to splashing when the product is dispensed. For laundry products having a low pH, splashing the laundry product onto surfaces with which the laundry product is not intended to contact can result in unwanted residues being left behind on such surfaces. Such laundry products can also be corrosive to surfaces contacted by the laundry product.

With these limitations in mind, there is a continuing unaddressed need for liquid laundry products having low pH that can be conveniently dispensed.

### SUMMARY OF THE INVENTION

A laundry product comprising: a liquid composition having a pH from 1 to 6; and a container comprising a base, a sidewall extending from said base to a neck; and a closure, wherein said closure comprises: a top profile having an exterior surface and an interior surface opposite said exterior surface; a spud projecting from said interior surface; a hinge engaging said top profile to a main body; an abutment in said main body sealingly engaged with said spud, wherein said abutment extends around a longitudinal axis passing through said top profile and said spud; a collar engaged with said abutment and oriented away from said top profile, wherein said collar is engaged with said neck; a floor peripherally bounded by said abutment; a sealing member that is at least part of said floor, wherein said sealing member is peripherally bounded by a frangible boundary extending around said longitudinal axis; a tab extending from said sealing member towards said top profile; wherein said sealing member and said abutment are a continuous single constitutive material.

### BRIEF DESCRIPTION OF THE DRAWINGS

FIG. 1 is closure with the top profile in an open position and the sealing member not yet removed from the closure.

FIG. 2 is a top view of a closure with the top profile in an open position.

FIG. 3 is a bottom view of a closure with the top profile in an open position.

FIG. 4 is a bottom perspective view of a closure.

### DETAILED DESCRIPTION OF THE INVENTION

The closure described herein can be practical for use as a closure to a container containing liquid laundry product. The closure can be advantageous for laundry products that include a liquid composition having a pH from 1 to 6, optionally liquid compositions that also have a kinematic viscosity less than 1 mPa·s. Liquid compositions of this type may be easily spilled or splashed upon a surface and leave a residue behind on such surface when the volatile components of the liquid composition volatilize. Moreover, such liquid compositions can be corrosive to surfaces contacted therewith.

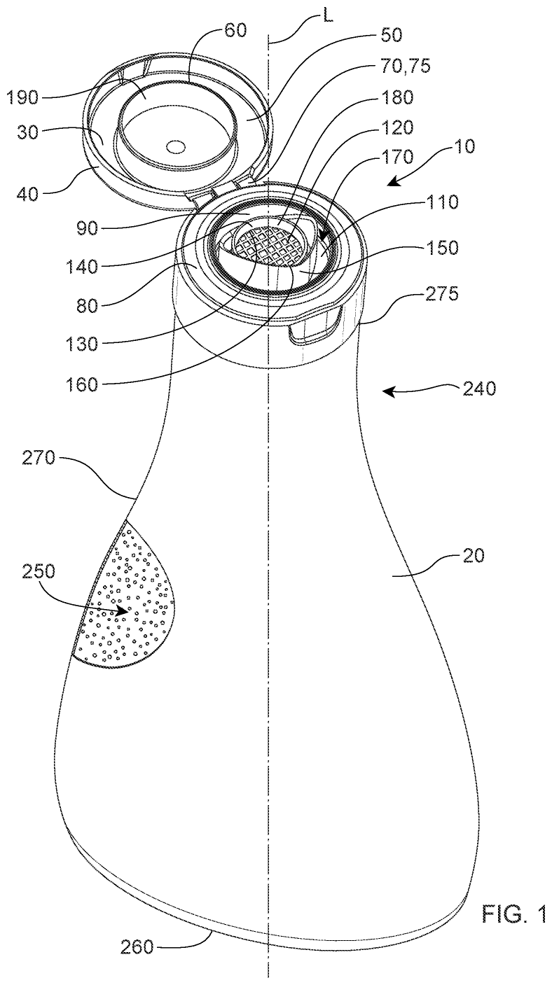

A closure 10 for a container 20 is shown in FIG. 1. The closure 10 shown in FIG. 1 is a flip top closure. The closure 10 can comprise a top profile 30. The top profile 30 can be a plate, shell, or other shape of constitutive material. The top profile 30 is the top of the closure 10 when the closure is engaged with the container 20 and the container 20 is in the upright position in which the neck 275 of the container 20 above the base 260 of the container 20.

The closure 10 can be practical for use as part of the package for a laundry product 240. The laundry product 240 can comprise a liquid composition 250 and a container 20. The container 20 can have a base 260 and a sidewall 270 extending from the base 260 to a neck 270.

The top profile 30 can have an exterior surface 40 and an interior surface 50 opposite the exterior surface 40. When the closure 10 is closed, the interior surface 50 is on the inside of the closure 10. The exterior surface 40 is exposed to the environment with the closure 10 is in its closed condition.

A spud 60 can project from the interior surface 50. The spud 60 is an element that can provide for a seal when the top profile 30 is in a closed position. A hinge 70 can engage the top profile 30 to the main body 80 of the closure 10. The top profile 30 can be swung about the hinge 70 to move the top profile 30 from a closed position to an open position. Optionally, the hinge 70 can be a living hinge 75. A living hinge 75 is a hinge 70 that has at least two stable low energy states and an energy state between the two stable low energy states that is higher than each of the two low energy states. That is, a living hinge 75 stores some energy as top profile 30 is rotated about the living hinge 75 from a closed position to an open position. The energy state between the two stable low energy states can be high enough that the mass of the top profile 30 is not sufficient for the top profile 30 to rotate from an open position to a closed position when acted upon by the force of gravity. That can help reduce the potential for the top profile 30 to unintentionally interfere with dispensing of the contents of the container 20.

The main body 80 can comprise an abutment 90. The abutment 90 can be sealingly engaged with the spud 60. The tight and continuous fit between the spud 60 and the abutment 90 can provide for a leak tight seal to retain the contents of the container 20 after the user first uses the closure 10 for dispensing the contents of the container 20. The spud 60 can be a continuous flange 190 that extends around the longitudinal axis L. Optionally, the continuous flange 190 can be nearer to the longitudinal axis L than the abutment. Optionally, the abutment 90 can be nearer to the longitudinal axis L than the continuous flange 190.

The abutment 90 can extend around a longitudinal axis L passing through the top profile 30 and the spud 60 when the closure 10 is closed. The abutment 90 can be sealingly engaged with the spud 60 entirely around the longitudinal axis L. The spud 60 can be inboard of the abutment 90 so that the spud 60 is nearer to or coincident with the longitudinal axis L than the abutment 90. Optionally, the spud 60 be outboard of the abutment 90 so that the abutment is nearer to the longitudinal axis L than the spud 60. In such an arrangement, the spud 60 can be a continuous flange 190 that sealingly engages with a surface of the abutment 90 oriented away from the longitudinal axis L.

The closure 10 can further comprise a collar engaged with the abutment 90. The collar can be oriented away from the top profile 30. The collar can be the part of the closure 10 that can be engaged, and optionally disengaged, with the container 20. For example, the collar can be provided with a bead that can snap fit to a complementary structure on the neck 275 of the container 20. Optionally the collar can be provided with threads to attach the collar to complementary threads positioned on the neck 275 of the container 20. Optionally, the collar can comprise lugs that are engageable with a complementary bayonet fitting positioned on the neck 275 of the container 20. The collar can be engaged with the interior, exterior, or both the interior and exterior of the neck 275 of the container 20. Optionally, the collar can be welded, glued, or otherwise attached to one or both of the interior or the exterior of the neck 275 of the bottle.

The closure 10 can further comprise a floor 110 peripherally bounded by the abutment 90. The floor 110 can form at least part of a thin walled structure that forms a leak tight closure of the collar before the user has prepared to the closure 10 to be ready for dispensing the contents of the container 20.

The closure 10 can comprise a sealing member 120 that is at least part of, or optionally an entirety of, the floor 110. The sealing member 120 can be peripherally bounded by a frangible boundary 130 extending around the longitudinal axis L. A tab 140 can extend from the sealing member 120 towards the top profile 30. The tab 140 can extend from the sealing member 120 in a direction away from the collar.

To operate the closure 10 in the first instance, the user flips open the top profile 30 by rotating the top profile 30 about the hinge 70. That presents the internals of the closure 10 to the user. The user then pulls on the tab 140 to remove the tab 140 from the closure 10. Depending on the configuration of the internals of the closure 10, the entirety of the floor 110 or part of the floor 110 is removed, which leaves an opening through which the contents of the container 20 can be dispensed.

The sealing member 120 can be beneficial in that it requires purposeful configuration of the closure 10 to render the closure 10 operable for dispensing the liquid composition contained in the container 20 with which the closure 10 is engaged. Flip top closures sometimes unintentionally flip open between the time when the closure 10 applied to the container 20 when the laundry product is manufactured and the when the product is first used by the user. The sealing member 120 reduces the possibility that the liquid composition splashes or spills from the container 20 in the event that the flip top closure opens unintentionally.

The sealing member 120 and the abutment 90 can be a continuous single constitutive material. Providing the sealing member 120 and the abutment 90 as a continuous single constitutive material has several benefits over similar closure systems in which the sealing member 120 and the abutment 90 are made of different materials. Firstly, when the sealing member 120 and the abutment 90 are a single continuous constitutive material, the components can be fabricated in a single shot injection molding process. Single shot injection molding is typically a much less expensive process on a cost per part produced basis. If two different constitutive materials are used, multi-shot injection molding may be required which complicates mold design, injection and curing of the various constitutive materials, and handling of the part as the closure is fabricated. Furthermore, when the same material constitutes the sealing member 120 and the abutment 90, the potential issue of weak connections between different components fabricated from different constitutive materials is abated. If two different constitutive materials are used, the constitutive materials must be carefully selected to ensure that a leak tight connection can be formed between the two constitutive materials. Optionally, the sealing member 120, the abutment 90, and the optional spout 150 can be a continuous single constitutive material. Optionally, the top profile 30, spud 60, hinge, 70, abutment 90, collar, floor 110, optional spout 150, sealing member 120, and tab 140 can be a continuous single constitutive material. Such a structure is conveniently molded by way of a single shot injection molding process. Optionally, the sealing member 120, the abutment 90, and the spout 150 can be a continuous single constitutive material. Providing a closure 10 constituted by a single constitutive material can provide for a closure 10 that can be conveniently placed in a single recycling stream. A closure 10 in which the sealing member 120 is fabricated from one polymeric material and the remainder of the closure is fabricated from another polymeric material can make the closure more difficult to recycle in a single recycling stream. Even when the sealing member 120 is removed from the closure 10, there may be remnants of the material constituting the sealing member 120. If the sealing member 120 material differs from the remainder of the closure 10, recycling of the used closure 10 may be complicated.

The single constitutive material can be EVERCAP DMDA-124 NT 7 high density polyethylene available from Dow Incorporated, Midland, Michigan, United States of America. The single constitutive material can be selected from the group of high density polyethylene, low density polyethylene, polypropylene, nylon, polyethylene terephthalate, and mixtures thereof.

Optionally, the closure can be engaged with a container 20 comprised of the same single constitutive material as the sealing member. Using the same constitutive material for the closure 10 and container 20 can provide for a package that that can be recycled in a single stream, which is more efficient than requiring sorting closure 10 and container 20 into different recycling streams. The container 20 and the closure 10 can be comprised of high density polyethylene.

The frangible boundary 130 can be thinner than parts of the sealing member 120 along the frangible boundary 130. The frangible boundary 130 can be a thinned section of the constitutive material forming the sealing member 120 and the abutment 90. For example, the frangible boundary 130 can have a thickness that is from about 2% to about 20%, optionally from about 5% to about 15%, of the thickness of the constitutive material on either side of the frangible boundary. The frangible boundary 130 can have a width that is from about 2% to about 20%, optionally from about 5% to about 15%, of the thickness of the constitutive material on either side of the frangible boundary. The frangible boundary 130 can have a thickness of about 0.1 mm. The frangible boundary 130 can have a width of about 0.2 mm. A frangible boundary 130 configured as such can be easy for the user to tear yet strong enough that the frangible boundary 130 will not separate unintentionally.

The closure 10 can optionally further comprise a spout 150 projecting from the floor 110 towards the top profile 30. The spout 150 can extend at least partially around the longitudinal axis L. The spout 150 can be nearer to the longitudinal axis L than the abutment 90. That is, the spout 150 can be surrounded by the abutment 90.

Including a spout 150 as part of the closure 10 can help constrain pouring of the contents of the container 20. For compositions having a low pH that are contained in the container 20, the spout 150 can help the person dispensing the composition avoid having splashes of the composition uncontrollably disperse during dispensing and unintentionally contacting surfaces for which contact with such materials is not intended.

The sealing member 120 can be at least partially peripherally bound by the spout 150. The frangible boundary 130 can demarcate the boundary between the sealing member 120 and the spout. When the user removes the sealing member 120 by pulling on the tab 140, the spout 150 can be thereby opened so that the contents of the container 20 can be dispensed by pouring them through the spout 150.

The spout 150 can have a dispensing lip 160. The longitudinal axis L can be between the dispensing lip 160 and the hinge 70. Such an arrangement can be practical in that when the top profile 30 is opened and swung about the hinge 70, the top profile 30 and the dispensing lip 160 of the spout are on opposite sides of the hinge 70. In that position, the top profile 30 does not obstruct or potentially interfere with dispensing the contents of the container 20 through the spout 150.

A drain back channel 170 can be defined by part of the abutment 90, part of the spout 150, and part of the floor 110 connecting the abutment 90 and the and the spout 150. The drain back channel 170 can catch drips or spillage from the dispensing lip 160 or other parts of the spout 150 and channel that material to a location at which that material may enter the container 20. When the closure 10 is in a position such that the dispensing lip 160 is above the collar the drain back channel 170 can be sloped in direction away from beneath the dispensing lip 160. Arranged as such, the drain back channel 170 drains in a direction away from beneath the dispensing lip 160.

Upon instigating the first use of the contents of the container 20, the user can remove the sealing member 120 from the closure 10 by pulling on the tab 140. The tab 140 can be a loop 180. When the top profile 30 is in a closed position, the loop 180 can be positioned between the floor 110 and the top profile 30. In such a position, the sealing member 120 can be between the tab and the collar. Optionally, the longitudinal axis L can pass through the loop 180. The loop 180 can be sized and dimensioned such that it can be gripped by adult human and pulled upon to separate the sealing member 120 from the other parts of the closure 10. The loop 180 can be gripped by the user's thumb and index finger. Optionally, the loop 180 can have an open area sized and dimensioned to receive an adult human index finger so that the user can pull on the loop 180 with his or her index finger. The loop 180 can have an open area from about 50 mm² to about 500 mm², optionally from about 100 mm² to about 400 mm², optionally from about 150 mm² to about 350 mm².

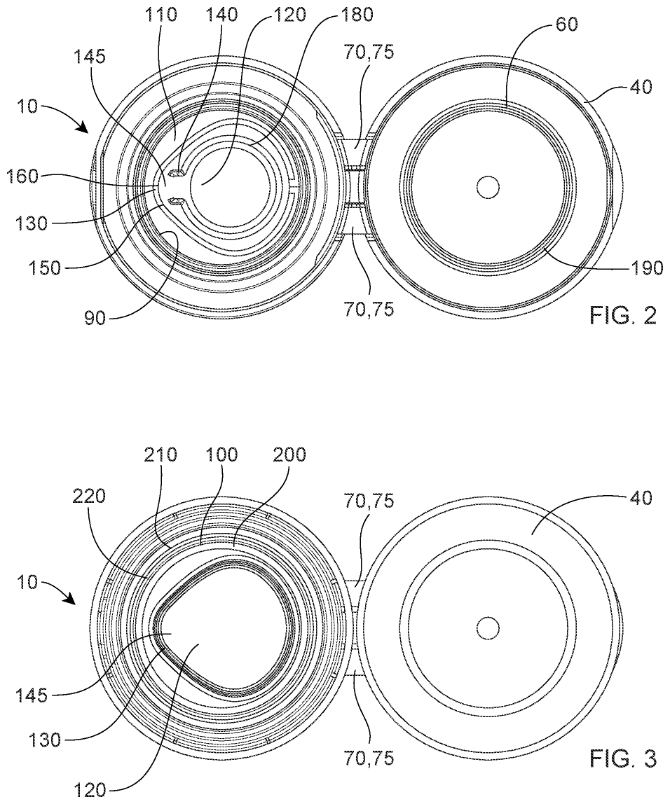

The tab 140 can extend from the sealing member 120 at an initiation location 145. The longitudinal axis L can be between the initiation location 145 and the hinge 70 (FIG. 2). That can be helpful to the user in that when the top profile 30 is opened and swung about the hinge, the top profile 30 does not interfere with the user finding and pulling on the tab 140 to remove the sealing member 120.

The spud 60 forms a plug seal to the abutment 90. The spud 60 can be oversized relative to the footprint of the interior periphery of the abutment 90 and form the plug seal between the spud 60 and the interior periphery of the abutment 90. Optionally, the spud 60 can be a continuous flange 190 extending around the longitudinal axis L. The continuous flange 190 can be a thin walled structure that is pliable and conforms to the interior periphery of the abutment 90. The continuous flange 190 can have a thickness measured orthogonal to the longitudinal axis L from about 0.5 mm to about 3 mm, optionally from about 0.5 mm to about 2 mm. The continuous flange 190 can project away from the top profile 30 by from about 2 mm to about 20 mm, optionally from about 5 mm to about 15 mm. The continuous flange 190 can have a circular shape that tightly conforms with a circular interior periphery of the abutment 90. Other smooth walled shapes for the continuous flange 190 and interior periphery of the abutment 90, such as tear drop shaped, oval, and oblong, are contemplated. The continuous flange 190 can provide for a degree of pliability to the structure of the spud 60 so that the continuous flange 190 can conform to the interior periphery of the abutment 90 even if there are small irregularities in the shape of one or both of the interior periphery of the abutment 90 or continuous flange 190.

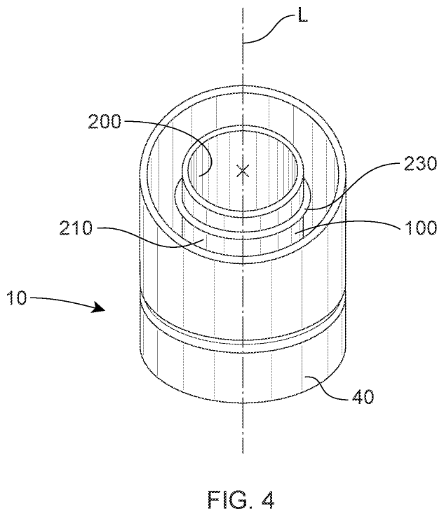

The collar can be the part of the closure 10 that is attachable, and optionally attachable and detachable, to the container 20. The collar 100 can have an inwardly oriented surface 200 oriented towards the longitudinal axis L and an outwardly oriented surface 210 oriented away from the longitudinal axis L (FIG. 3). The inwardly oriented surface 200 or the outwardly oriented surface 210 can comprise threads 220. Optionally, the inwardly oriented surface 200 or the outwardly oriented surface 210 can comprise a snap bead 230 (FIG. 4). The collar 100 can be engaged with the container 20 by the threads 220 or snap bead 230. The collar 100 can engage with the interior of the neck 275 of the container 20, exterior of the neck 275 of the container 20, both the interior and exterior of the neck 275 of the container 20.

The liquid composition 250 can have a pH from 1 to 6. Liquid compositions having an acidic pH can be useful for softening fabrics and/or for rejuvenating colors by removing limescale that may have accumulated on the fabrics, which can result from washing one's fabrics in hard water. The liquid composition 250 can have a pH from about 2 to about 5, optionally from about 3 to about 4, optionally from about 2 to about 3. The liquid composition 250 can be applied to a load of laundry during the rinse cycle of a laundry washing machine. The liquid composition 250 can be conveniently applied during the rinse cycle by employing the rinse additive dispenser drawer of the washing machine or other apparatus provided as part of the washing machine for applying rinse additives to the laundry.

The pH of the liquid composition 250 can be provided by citric acid or salt thereof. The pH of the liquid composition 250 can be provided by citric acid or salt thereof. The pH of the liquid composition 250 can be provided by a polycarboxylic acid. Optionally, the citric acid or salt thereof or polycarboxylic acid can be provided at a level of from about 10 percent by weight to about 50 percent by weight of the liquid composition 250. Optionally, the liquid composition 250 can comprise from about 15% to about 40%, optionally from about 20% to about 30%, by weight of the liquid fabric care composition, of citric acid and/or the salt thereof or polycarboxylic acid.

The liquid composition 250 of the present disclosure may have a Reserve Acidity to pH 4.0, of at least about 1, or at least about 3, or at least about 5. The liquid composition 250 can have a reserve acidity to pH 4.0 of from about 3 to about 10, or from about 4 to about 7. As used herein, “reserve acidity” refers to the grams of NaOH per 100 g of product required to attain the stated pH. The reserve acidity measurement as used herein is based upon titration (at standard temperature and pressure) of a 1% product solution in distilled water to an end point of pH 4.0, using standardized NaOH solution. Without being limited by theory, the reserve acidity measurement is found to be the best measure of the acidifying power of a composition, or the ability of a composition to provide a target acidic wash pH when added at high dilution into tap water as opposed to pure or distilled water. The reserve acidity is controlled by the level of formulated organic acid along with the neat product pH as well as, in some aspects, other buffers, such as alkalizing agents, for example, alkanolamines.

The liquid composition 250 can comprise from about 0.01 percent to about 20 percent by weight of the liquid composition of perfume. Perfume may provide for a pleasing scent to the liquid composition 250. Non-limiting examples of perfumes include, but are not limited to, aldehydes, ketones, esters, and the like. Other examples include various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise complex mixtures of such ingredients.

The liquid composition 250 can be an aqueous solution. The liquid composition can comprise from about 30 percent to about 90 percent by weight of the liquid composition of water. Optionally, the liquid composition can comprise from about 50 percent to about 90 percent, optionally from about 60 percent to about 85%, optionally from about 70 percent to about 80%, by weight of the liquid composition of water.

Optionally, the liquid composition 250 can comprise an organic acid. The organic acid can be selected from the group of acetic acid, lactic acid, adipic acid, aspartic acid, carboxymethyloxymalonic acid, carboxymethyloxysuccinic acid, glutaric acid, hydroxyethlyliminodiacetic acid, iminodiactic acid, maleic acid, malic acid, malonic acid, oxydiacetic acid, oxydisuccinic acid, succinic acid, sulfamic acid, tartaric acid, tartaric-discuccinic acid, tartaric-monosuccinic acid, or mixtures thereof.

The liquid composition 250 can be characterized by a relatively low viscosity. Such viscosities may be desirable for convenient pouring and/or little hang-up in a machine's dispenser drawer. The liquid composition 250 can have a kinematic viscosity less than 2 mPa·s according to ASTM D2169-99 at 60 rpm and 22 C. Optionally, the liquid composition 250 can have a kinematic viscosity less than 1.5 mPa·s according to ASTM D2169-99 at 60 rpm and 22 C. Optionally, the liquid composition 250 can have a kinematic viscosity less than 1 mPa·s according to ASTM D2169-99 at 60 rpm and 22 C.

In an effort to keep viscosity low, the liquid composition 250 may be substantially free of thickeners or other rheology enhancers, such as structurants. The liquid composition 250 may be substantially free of salts, such as inorganic salts like sodium chloride, magnesium chloride, and/or calcium chloride, that can provide rheology modification such as thickening. As used herein, such salts are not intended to include the neutralization products of the organic acids described herein.

The liquid composition 250 can be a formula as set forth in Table 1.

TABLE 1
Liquid compositions.

| Material | Percent by Weight of Liquid Composition |
|---|---|
| Citric Acid | 20 |
| Sodium Citrate | 4.5 |
| Formic Acid | 0.1 |
| Propanediol | 5 |
| Nonionic Surfactant | 4 |
| Sodium Cumene Sulphonate | 1 |
| Perfume | 0.01-20 (optional) |
| Water | Balance |

An example is below:

A. A laundry product (240) comprising:
a liquid composition having a pH from 1 to 6; and
a container (20) comprising a base (260), a sidewall (270) extending from said base to a neck (275); and
a closure (10), wherein said closure comprises:
a top profile (30) having an exterior surface (40) and an interior surface (50) opposite said exterior surface;
a spud (60) projecting from said interior surface;
a hinge (70) engaging said top profile to a main body (80);
an abutment (90) in said main body sealingly engaged with said spud, wherein said abutment extends around a longitudinal axis (L) passing through said top profile and said spud;
a collar (100) engaged with said abutment and oriented away from said top profile, wherein said collar is engaged with said neck;
a floor (110) peripherally bounded by said abutment;
a sealing member (120) that is at least part of said floor, wherein said sealing member is peripherally bounded by a frangible boundary (130) extending around said longitudinal axis;
a tab (140) extending from said sealing member towards said top profile;
wherein said sealing member and said abutment are a continuous single constitutive material.

B. The laundry product according to Paragraph A, wherein said liquid composition has a viscosity less than 2 mPa·s according to ASTM D2169-99 at 60 rpm and 22 C.

C. The laundry product according to Paragraph A or B, wherein said liquid composition comprises from about 30 percent by weight to about 90 percent by weight of said liquid composition of water.

D. The laundry product according to any of Paragraphs A to C, wherein said liquid composition comprises from about 0.01 percent by weight to about 20 percent by weight of said liquid composition of perfume.

E. The laundry product according to any of Paragraphs A to D, wherein said liquid composition comprises from about 10 percent by weight to about 50 percent by weight of said liquid composition of citric acid and or salt thereof.

F. The closure according to any of Paragraphs A to E, wherein said closure further comprises:
a spout (150) projecting from said floor towards said top profile, wherein said spout extends at least partially around said longitudinal axis and is nearer to said longitudinal axis than said abutment.

G. The closure according to any of Paragraphs A to F, wherein sealing member is at least partially peripherally bound by said spout.

H. The closure according to Paragraph G, wherein said sealing member, said abutment, and said spout are a continuous single constitutive material.

I. The laundry product according to any of Paragraphs A to H, wherein said container in an unopened state is devoid of a membrane seal on said neck.

J. The laundry product according to any of Paragraphs A to I, wherein said liquid composition comprises from about 30 percent by weight to about 90 percent by weight of said liquid composition of water.

K. The laundry product according to any of Paragraphs A to J, wherein said container is devoid of adhesive on said neck.

L. The laundry product according to any of Paragraphs A to K, wherein said container in an unopened state is devoid of a membrane seal on said neck.

M. The laundry product according to any of Paragraphs A to L, wherein said liquid composition comprises from about 10 percent by weight to about 50 percent by weight of said liquid composition of polycarboxylic acid.

N. The laundry product according to any of Paragraphs A to M, wherein said closure further comprises: a spout (150) projecting from said floor towards said top profile, wherein said spout extends at least partially around said longitudinal axis and is nearer to said longitudinal axis than said abutment wherein said spout has a dispensing lip (160) and said longitudinal axis can be between said dispensing lip and said hinge, wherein a drain back channel (170) is defined by part of said abutment, part of said spout, and part of said floor connecting said abutment and said spout, wherein when said closure is in a position such that said dispensing lip is above said collar said drain back channel is sloped in a direction away from beneath said dispensing lip.

O. The laundry product according to any of Paragraphs A to N, wherein said tab is a loop (180), wherein said loop is positioned between said floor and said top profile, optionally wherein said longitudinal axis passes through said loop.

P. The laundry product according to any of Paragraphs A to O, wherein said spud is a continuous flange (190) extending around said longitudinal axis.

Q. The laundry product according to any of Paragraphs A to P, wherein said closure further comprises:
a spout projecting from said floor towards said top profile, wherein said spout extends at least partially around said longitudinal axis and is nearer to said longitudinal axis than said abutment, wherein said sealing member, said abutment, and said spout are a continuous single constitutive material.

R. The laundry product according to any of Paragraphs A to Q, wherein said abutment is sealingly engaged with said spud entirely around said longitudinal axis.

S. The laundry product according to any of Paragraphs A to R, wherein said liquid composition has a reserve acidity to pH 4.0 of at least about 1, or at least about 3, or at least about 5.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A laundry product comprising:
a liquid composition having a pH from 1 to 6; and
a container comprising a base, a sidewall extending from said base to a neck; and
a closure, wherein said closure comprises:
a top profile having an exterior surface and an interior surface opposite said exterior surface;
a spud projecting from said interior surface;
a hinge engaging said top profile to a main body;
an abutment in said main body sealingly engaged with said spud, wherein said abutment extends around a longitudinal axis passing through said top profile and said spud;
a collar engaged with said abutment and oriented away from said top profile, wherein said collar is engaged with said neck;
a floor peripherally bounded by said abutment;
a sealing member that is at least part of said floor, wherein said sealing member is peripherally bounded by a frangible boundary extending around said longitudinal axis;
a tab extending from said sealing member towards said top profile;
wherein said sealing member and said abutment are a continuous single constitutive material.

2. The laundry product according to claim 1, wherein said liquid composition has a viscosity less than 2 mPa·s according to ASTM D2169-99 at 60 rpm and 22 C.

3. The laundry product according to claim 2, wherein said liquid composition comprises from about 30 percent by weight to about 90 percent by weight of said liquid composition of water.

4. The laundry product according to claim 3, wherein said liquid composition comprises from about 0.01 percent by weight to about 20 percent by weight of said liquid composition of perfume.

5. The laundry product according to claim 3, wherein said liquid composition comprises from about 10 percent by weight to about 50 percent by weight of said liquid composition of citric acid and or salt thereof.

6. The closure according to claim 3, wherein said closure further comprises:
a spout projecting from said floor towards said top profile, wherein said spout extends at least partially around said longitudinal axis and is nearer to said longitudinal axis than said abutment.

7. The laundry product according to claim 3, wherein said container in an unopened state is devoid of a membrane seal on said neck.

8. The closure according to claim 3, wherein sealing member is at least partially peripherally bound by said spout.

9. The closure according to claim 8, wherein said sealing member, said abutment, and said spout are a continuous single constitutive material.

10. The laundry product according to claim 1, wherein said liquid composition comprises from about 30 percent by weight to about 90 percent by weight of said liquid composition of water.

11. The laundry product according to claim 1, wherein said container is devoid of adhesive on said neck.

12. The laundry product according to claim 1, wherein said container in an unopened state is devoid of a membrane seal on said neck.

13. The laundry product according to claim 1, wherein said liquid composition comprises from about 10 percent by weight to about 50 percent by weight of said liquid composition of polycarboxylic acid.

14. The laundry product according to claim 1, wherein said liquid composition has a reserve acidity to pH 4.0 of at least about 1.

15. The laundry product e according to claim 1, wherein said closure further comprises:
a spout projecting from said floor towards said top profile, wherein said spout extends at least partially around said longitudinal axis and is nearer to said longitudinal axis than said abutment.

16. The laundry product according to claim 15, wherein sealing member is at least partially peripherally bound by said spout.

17. The laundry product according to claim 16, wherein said spout has a dispensing lip and said longitudinal axis can be between said dispensing lip and said hinge, wherein a drain back channel is defined by part of said abutment, part of said spout, and part of said floor connecting said abutment and said spout, wherein when said closure is in a position such that said dispensing lip is above said collar said drain back channel is sloped in a direction away from beneath said dispensing lip.

18. The laundry product according to claim 17, wherein said tab is a loop, wherein said loop is positioned between said floor and said top profile.

19. The laundry product according to claim 18, wherein said spud is a continuous flange extending around said longitudinal axis.

20. The laundry product according to claim 1, wherein said closure further comprises:
a spout projecting from said floor towards said top profile, wherein said spout extends at least partially around said longitudinal axis and is nearer to said longitudinal axis than said abutment, wherein said sealing member, said abutment, and said spout are a continuous single constitutive material.
